(19) United States
(12) Patent Application Publication
(10) Pub. No.: US 2025/0230918 A1
(43) Pub. Date: Jul. 17, 2025

(54) LUMINARY WITH A PLURALITY OF EMISSION ANGLES

(71) Applicant: FoxFury LLC, Oceanside, CA (US)

(72) Inventors: Mario Cugini, Oceanside, CA (US); Thomas Horner, Oceanside, CA (US); Chris Raven, Oceanside, CA (US)

(73) Assignee: FoxFury LLC, Oceanside, CA (US)

(21) Appl. No.: 19/021,779

(22) Filed: Jan. 15, 2025

Related U.S. Application Data
(60) Provisional application No. 63/620,954, filed on Jan. 15, 2024.

(51) Int. Cl. F21V 7/00; F21V 21/22; F21Y 105/10

(52) U.S. Cl. CPC F21V 7/0083; F21V 21/22; F21Y 2105/10

(57) ABSTRACT

A luminary is disclosed that provides simultaneous area and distance lighting through multiple light sources equipped with fixed light guides. Each light guide directs light at a specific emission angle, enabling the device to deliver wide-angle area lighting and focused distance lighting without requiring manual adjustments. The light sources are arranged in a housing that allows light emission in a single direction, with overlapping illumination to ensure seamless blending of lighting zones. The luminary is designed for applications such as construction, law enforcement, vehicle lighting, emergency and scene lighting, and portable or battery-operated uses. The luminary can be used with tactical shields, rotating light guide assemblies, and tripod mounts for enhanced versatility. The system enhances operational efficiency by eliminating the need for mechanical or electronic transitions between lighting states, making it particularly useful in time-sensitive or hazardous environments.

### CROSS-REFERENCE TO RELATED APPLICATIONS

This application claims benefit of priority with U.S. Provisional Application Ser. No. 63/620,954, filed Jan. 15, 2024; the entire contents of which are hereby incorporated by reference.

### BACKGROUND

### Field of the Invention

This invention relates to luminaries; more particularly, to luminaries with a plurality of emission angles to concurrently emit both area lighting and distance lighting.

### Description of the Related Art

Emissions from a light source can be redirected over a wide variety of emission patterns depending on design of a light guide associated therewith. Each light guide is designed to produce a particular emission angle. Wider emission angles are designed for area lighting, illuminating a broad area near the luminary, while narrower emission angles focus light for distance illumination. Luminaries are generally designed for an application of either area or distance lighting. Current luminaries designed for both applications allow an operator to alter between area and distance lighting by mechanical or electrical manipulation. Examples include placing a diffuser over the light source when area lighting is desired, and to remove the diffuser when distance lighting is desired, and using a second hand to manually twist/focus the lead head. In certain applications, changing between lighting states can be burdensome and in particular time critical situations is not an option.

There is a need for a luminary that produces both area and distance lighting without requiring an operator to install or otherwise switch between the lighting states.

### SUMMARY

A luminary with plurality of emission angles is disclosed. The luminary comprises a plurality of light sources, each having a light guide. Each of the light guides is designed to transmit light at one of a plurality of emission angles. The luminary is configured to concurrently produce an area lighting and a distance lighting. In some embodiments, each of the light guides is a permanent light guide which allows a user to have both area and distance lighting without having to transition between lighting states.

The luminary with plurality of emission angles can be used with various applications including construction, police, vehicle lighting, portable lighting, battery operated lighting, and any other application as can be appreciated by one having skill in the art. Blending of area lighting and distance lighting can be used to record crime scenes and enhance documentation taken by investigators and drones with photography and 3D scanners. A plurality of luminaries can be used to provide 360 area coverage.

### BRIEF DESCRIPTION OF THE DRAWINGS

Other features, combinations, and embodiments will be appreciated by one having the ordinary level of skill in the art of luminaries and accessories upon a thorough review of the following details and descriptions, particularly when reviewed in conjunction with the drawings, wherein:

FIG. 1 shows a front view of a luminary with a plurality of emission angles in accordance with a first illustrated embodiment;

FIG. 2 shows perspective view of a luminary with a plurality of emission angles in accordance with a second illustrated embodiment;

FIG. 3 shows front view of the luminary with the plurality of emission angles according to the second illustrated embodiment;

FIG. 4 shows a front view of a luminary with a plurality of emission angles in accordance with a third illustrated embodiment;

FIG. 5A shows a perspective view of the luminary with the plurality of emission angles according to the third illustrated embodiment;

FIG. 5B shows a side view of the luminary with the plurality of emission angles according to the third illustrated embodiment;

FIG. 6 shows a front view of a ballistic shield comprising the luminary with the plurality of emission angles according to the third illustrated embodiment;

FIG. 7 shows a side view of the ballistic shield comprising the luminary with the plurality of emission angles according to the third illustrated embodiment; and

FIG. 8 shows a top view of the luminary with the plurality of emission angles according to the third illustrated embodiment.

### DETAILED DESCRIPTION

For purposes of explanation and not limitation, details and descriptions of certain preferred embodiments are hereinafter provided such that one having ordinary skill in the art may be enabled to make and use the invention. These details and descriptions are representative only of certain preferred embodiments, however, a myriad of other embodiments which will not be expressly described will be readily understood by one having skill in the art upon a thorough review of the instant disclosure. Accordingly, any reviewer of the instant disclosure should interpret the scope of the invention only by the claims, as such scope is not intended to be limited by the embodiments described and illustrated herein.

The features, components, and configurations described in connection with the various embodiments illustrated herein may be combined, interchanged, or otherwise modified in any number of ways without departing from the scope and spirit of the invention. The embodiments are presented by way of example and not limitation, and it is intended that the invention encompasses all such combinations, permutations, and modifications as would be understood by those skilled in the art.

For purposes herein, the term “luminary” means an artificial or man-made source of illumination, such as a lamp, light fixture, lantern, or any other lighting device that produces light to brighten or illuminate its surroundings. Luminary devices are designed to emit light for practical purposes, such as lighting up indoor or outdoor spaces, providing visibility, and creating an illuminated environment.

The term “light guide” means an optical component or device designed to transmit and control the propagation of light within various applications, typically using materials such as glass or plastic to guide and direct light efficiently. A light guide can include, but is not limited to, an optical lens, refractor, diffuser, or collimator.

The term “emission angle” means a full angle of light output comprising both half angles.

The term “area lighting” means a light source having a light guide configured to transmit a light output having an emission angle of 25 degrees or more.

The term “distance lighting” means a light source having a light guide configured to transmit a light output having an emission angle of 20 degrees or less.

The term “permanent light guide” means a light guide that is immobile, static, and fixed to the corresponding light source the light guide is covering.

The term “blended light” means a luminary concurrently emitting light at different emission angles in order to achieve both area lighting and distance lighting.

The term “white light” means visible light that comprises a mixture of all the colors of the visible spectrum, appearing as a neutral or colorless illumination.

The term “collectively controlled” means to operate from the same power source such that turning off power from one light source will also turn off power to the other light sources.

The term “tactical shield” means a specialized protective shield for use by law enforcement, military personnel, or other security professionals in potentially dangerous situations. Tactical shields can include, not is not limited to, ballistic shields and riot shields.

Unless explicitly defined herein, terms are to be construed in accordance with the plain and ordinary meaning as would be appreciated by one having skill in the art.

### GENERAL DESCRIPTION OF EMBODIMENTS

In a general embodiment, a luminary is disclosed. The luminary comprises a housing having a front side and a back side opposite the front side. A plurality of light sources is disposed on the front side, wherein each of the plurality of light sources emits a light output in a same direction. The luminary further comprises a plurality of permanent light guides, wherein each of the plurality of permanent light guides is disposed over one of the plurality of light sources. The plurality of permanent light guides comprises a first light guide having a first emission angle and a second light guide having a second emission angle. The first emission angle is less than the second emission angle such that the first light guide is configured for distance lighting and the second light guide is configured for area lighting. A light output from the area lighting is configured to emit concurrently with a light output from the distance lighting to provide simultaneous lighting coverage. At least a portion of the light output from the distance lighting is configured to overlap with at least a portion of the light output of the area lighting

In some embodiments, the plurality of light sources may be arranged in both a plurality of rows and a plurality of columns.

In some embodiments, the first emission angle may be at most 20 degrees and the second emission angle may be at least 30 degrees.

In some embodiments, each of the plurality of light guides may further comprise a light guide periphery wherein each light guide periphery is separate and distinct from each of the other light guide peripheries.

In some embodiments, the plurality of light guides may further comprise a third light guide having a third emission angle wherein the third emission angle is greater than the first emission angle and less than the second emission angle. The third light guide may be configured for distance lighting. In other embodiments, the third light guide may be configured for area lighting. In yet other embodiments, the third emission angle may comprise an angle between 20 degrees to 30 degrees. In some embodiments, the front side of the housing may comprise a plurality of rotating portions such that the first light guide is rotatable relative to at least one of the second light guide or the third light guide. In some embodiments, the front side of the housing may comprise a plurality of rotating portions such that the second light guide is rotatable relative to at least one of the first light guide or the third light guide. In some embodiments, the front side of the housing may comprise a plurality of rotating portions such that the third light guide is rotatable relative to at least one of the first light guide or the second light guide.

In some embodiments, the housing may be coupled to an extendable pole, the extendable pole being disposed within a tripod having a plurality of legs.

In some embodiments, the front side of the housing may comprise a plurality of rotating portions such that the first light guide is rotatable relative to the second light guide.

In some embodiments, the luminary may further comprise a plurality of second light guides wherein the first light guide is disposed collinearly with the plurality of second light guides. The first light guide may be disposed between a pair of the second light guides.

In some embodiments, the luminary may be coupled to a tactical shield at a front surface thereof, the tactical shield further comprising a viewing port extending from the front surface to a back surface opposite the front surface, wherein the luminary is disposed below the viewing port.

In some embodiments, wherein each of the plurality of light sources may be disposed under one of the plurality of light guides.

In some embodiments, the luminary may further comprise a number of second light guides and a number of first light guides wherein the number of second light guides is greater than the number first light guides.

In some embodiments, the front side may comprise each light source disposed on the luminary.

In some embodiments, the luminary may be configured to produce white light. In other embodiments, the luminary may be configured to produce monochromatic colors in addition to or instead of white light. In yet other embodiments, the luminary may be configured to produce infrared lighting in conjunction with a specialized camera or night vision device worn by the user. Use of infrared can provide enhanced perception of surrounding environment which can help military and law enforcement when stealth is preferred.

In some embodiments, each of the plurality of light sources may be collectively controlled.

In some embodiments, each of the plurality of permanent light guides are non-overlapping and are disposed on a same plane.

In some embodiments, the luminary may comprise a plurality of light outputs wherein each of the plurality of light sources corresponds to one of the plurality of light outputs.

In some embodiments, each of the plurality of light sources may comprise a single lighting component. In other embodiments, one or more of the plurality of light sources may comprise a plurality of lighting components.

In another general embodiment, a luminary is disclosed. The luminary comprises a housing having a front side and a back side opposite the front side, and a plurality of light sources disposed on the front side. The luminary further comprises a plurality of light guides wherein each of the plurality of light guides is disposed over one of the plurality of light sources. The plurality of light guides comprises a first light guide having a first emission angle and a second light guide having a second emission angle. The first emission angle is less than second emission angle. The first light guide is configured for distance lighting and the second light guide is configured for area lighting.

In some embodiments, the plurality of light sources may be arranged in both a plurality of rows and a plurality of columns.

In some embodiments, the first emission angle may be at most 20 degrees and the second emission angle may be at least 30 degrees.

In some embodiments, at least one of the plurality of light guides may comprise a permanent light guide.

In some embodiments, each of the plurality of light guides may comprise a permanent light guide.

In some embodiments, each of the plurality of light guides may further comprise a light guide periphery wherein each light guide periphery is separate and distinct from each of the other light guide peripheries.

In some embodiments, the plurality of light guides may further comprise a third light guide having a third emission angle wherein the third emission angle is greater than the first emission angle and less than the second emission angle. The third light guide may be configured for distance lighting or area lighting. In other embodiments, the third emission angle may comprise an angle between 20 degrees to 25 degrees. In yet other embodiments the third emission angle may comprise an angle between 20 degrees to 30 degrees. In some embodiments, the front side of the housing may comprise a plurality of rotating portions such that the first light guide is rotatable relative to at least one of the second light guide or the third light guide. In some embodiments, the front side of the housing may comprise a plurality of rotating portions such that the second light guide is rotatable relative to at least one of the first light guide or the third light guide. In yet other embodiments, the front side of the housing may comprise a plurality of rotating portions such that the third light guide is rotatable relative to at least one of the first light guide or the second light guide.

In some embodiments, the housing may be coupled to an extendable pole, the extendable pole being disposed within a tripod having a plurality of legs.

In some embodiments, a light output from the area lighting may be configured to emit concurrently with a light output from the distance lighting.

In some embodiments, the front side of the housing may comprise a plurality of rotating portions such that the first light guide is rotatable relative to the second light guide.

In some embodiments, the luminary may further comprise a plurality of second light guides wherein the first light guide is disposed collinearly with the plurality of second light guides. The first light guide may be disposed between a pair of the second light guides.

In some embodiments, each of the plurality of light sources may emit a light output in a same direction.

In some embodiments, at least a portion of a light output from the distance lighting may be configured to overlap with at least a portion of a light output from the area lighting.

In some embodiments, the luminary may be coupled to a tactical shield at a front surface thereof, the tactical shield further comprising a viewing port extending from the front surface to a back surface opposite the front surface, wherein the luminary is disposed below the viewing port.

In some embodiments, each of the plurality of light sources may be disposed under one of the plurality of light guides.

In some embodiments, the luminary may further comprise a number of second light guides and a number of first light guides wherein the number of second light guides is greater than the number of the first light guides.

In some embodiments, the front side may comprise each light source disposed on the luminary.

In some embodiments, the luminary may be configured to produce white light. In other embodiments, the luminary may be configured to produce monochromatic colors in addition to or instead of white light.

In some embodiments, each of the plurality of light sources may be collectively controlled.

In some embodiments, each of the plurality of light guides are non-overlapping and are disposed on a same plane.

In some embodiments, the luminary may comprise a plurality of light outputs wherein each of the plurality of light sources corresponds to one of the plurality of light outputs.

In some embodiments, each of the plurality of light sources may comprise a single lighting component. In other embodiments, one or more of the plurality of light sources may comprise a plurality of lighting components.

Each of the components of the luminary and related system described herein may be manufactured and/or assembled in accordance with the conventional knowledge and level of a person having skill in the art.

While various details, features, combinations are described in the illustrated embodiments, one having skill in the art will appreciate a myriad of possible alternative combinations and arrangements of the features disclosed herein. As such, the descriptions are intended to be enabling only, and non-limiting. Instead, the spirit and scope of the invention is set forth in the appended claims.

### First Illustrated Embodiment

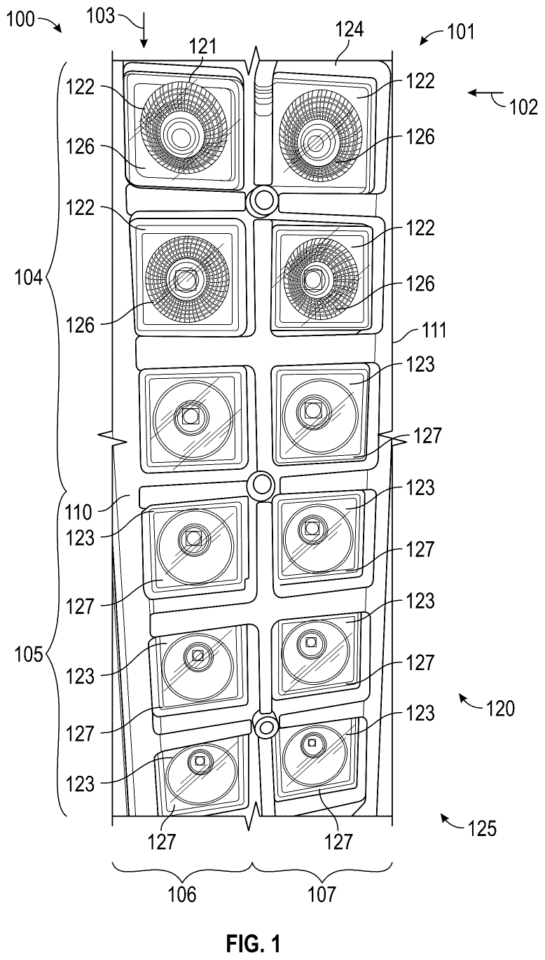

Now turning to the drawings, FIG. 1 shows a front view of a luminary (100) with a plurality of emission angles (125) in accordance with a first illustrated embodiment. The luminary can be characterized as a portable floodlight (101) configured to illuminate an outdoor area. The luminary comprises a housing (110) having a front side (111) and a back side (not shown) opposite the front side. Disposed on the front side are a plurality of light sources (120) arranged in both a plurality of rows (102) and a plurality of columns (103). The plurality of light sources are collectively controlled for synchronous powering on and off. Each of the plurality of light sources comprises a permanent light guide (121) being one of a first light guide (122) or a second light guide (123). In other embodiments, the luminary may comprise more than two light guides. Each of the first light guides and the second light guides are fixed and static to the front side of the housing. Each permanent light guide is characterized as being immobile and static. Each permanent light guide comprises a light guide periphery (124) which is separate and distinct from the light guide periphery of the other permanent light guides. The luminary is configured to concurrently transmit light in a same direction in order to create both an immediate area lighting and further distance lighting simultaneously without the need to mechanically transition between either state.

The first light guide (122) is configured to transmit a light having a first emission angle (126), and the second light guide (123) is configured to transmit a light having second emission angle (127) wherein the first emission angle is less than the second emission angle. This emission angle difference causes each of the first light guides to produce a more focused light for distance lighting compared to the second light guides which are configured for a closer area lighting. The luminary (100) can be used individually or with a tripod.

As shown, each of the first light guides (122) is disposed on the first two rows of the plurality of light rows (102) on an upper half (104) of the plurality of light sources (120). Other configurations for the first light guides can also be utilized as can be appreciated by one having skill in the art. For example, at least one of the first light guides can be disposed on the upper half with remaining of the first light guides disposed on a lower half (105). In other embodiments, each of the first light guides may be disposed on the lower half. In yet other embodiments, at least one of the first light guides may be disposed on a first lateral half (106) of the plurality of light sources and the remaining of the first lights guides may be disposed on a second lateral half. (107). In other embodiments, each of the first light guides may be disposed on the first lateral half, and yet in other embodiments each of the first light guides may be disposed on the second lateral half. As shown, the luminary comprises a number of the first light guides and a number of the second light guides (123) wherein the number of the second light guides is greater than the number of the first light guides.

### Second Illustrated Embodiment

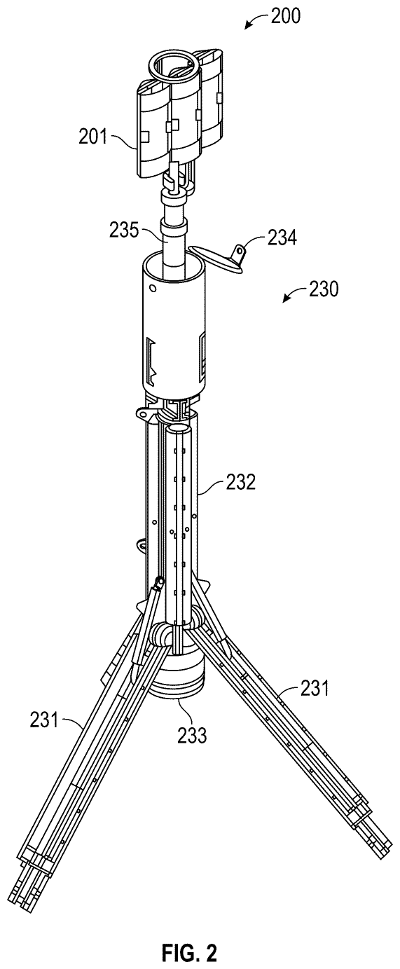

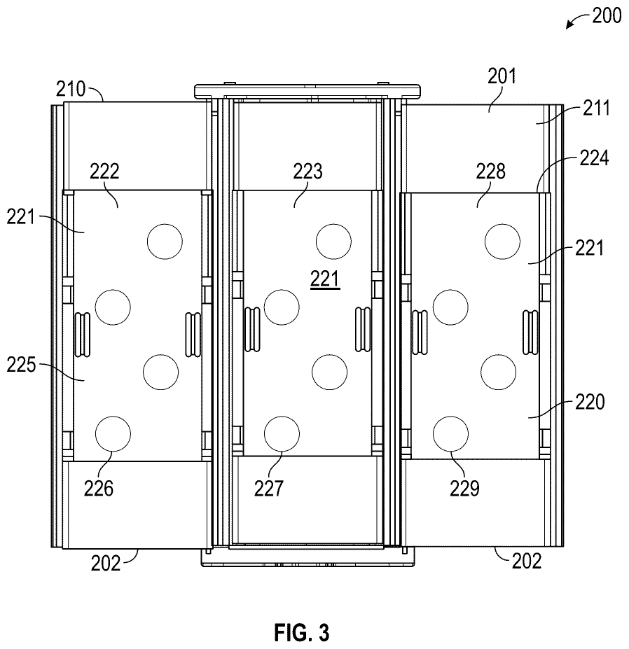

FIG. 2-3 show a luminary (200) with a plurality of emission angles (225) in accordance with a second illustrated embodiment. The luminary is coupled to an extendable pole (235) of an electrified tripod (230). The electrified tripod further comprises a plurality of tripod legs (231) and a protective light cap (234) for covering the luminary while in a collapsed state. The electrified tripod further comprises a battery system (232) for powering the luminary, and a charging port (233) for recharging the battery system. The luminary is configured to operate as a portable floodlight (201) to produce conventional area lighting while concurrently producing focused lighting for longer distance.

The floodlight (201) comprises a plurality of light sources (220) configured to produce a plurality of emission angles (225) to achieve both area and distance lighting. The luminary comprises a housing (210) with the plurality of light sources disposed on a front side (211) thereof. The front side comprises a plurality of rotating portions (202) hingedly coupled together. A permanent light guide (221) is disposed in front of each of the plurality of light sources such that each permanent light guides is disposed on one of the plurality of rotating portions. Each permanent light guide comprises a light guide periphery (224) separate and distinct from each other light guide periphery. The permanent light guides comprise a first light guide (222), a second light guide (223), and a third light guide (228). The first and third light guides are each hingedly coupled to the second light guide disposed at a center thereof. When the plurality of rotating portions is in a planar formation as shown in FIG. 3, each of the plurality of light sources is configured to produce a light output in a same direction.

The first light guide (222) is associated with a first emission angle (226), the second light guide (223) is associated with a second emission angle (227), and the third light guide (228) is associated with a third emission angle (229), wherein the first emission angle is less than each of the second emission angle and the third emission angle, and further wherein the second emission angle is greater than the third emission angle. The floodlight is configured to concurrently produce immediate area lighting from the second light guide and a focused distance lighting with the first light guide. The third light guide is configured to produce a lighting between the first light guide and the second light guide. The third light guide may be configured to produce area lighting having an emission angle greater than 30 degrees, distance lighting having an emission angle less than 20 degrees, or a lighting between 20 degrees and 30 degrees.

In other embodiments, the luminary (200) with the plurality of rotating portions (202) may comprise only the first light guide (222) and the second light guides (223) arranged on the plurality of rotating portions. For example, the luminary may comprise a single first light guide configured for distance lighting and two second light guides configured for area lighting. Alternatively, the luminary may comprise two first light guides and a single second light guide.

As shown, each of the plurality of light sources (220) comprises a plurality of lighting components, such a bulb or LED. In other embodiments, the plurality of light sources may comprise laser or other lighting sources. Alternatively, one or more of plurality of light sources may comprise a single lighting component as illustrated in FIG. 1.

The first light guide (222), the second light guide (223), and the third light guide (228) are each permanent light guides (221) to achieve both area and distance lighting concurrently without a need for the operator to make changes or alterations. This can be especially advantageous during critical times where changing lighting states back and forth is undesirable or even dangerous. Each permanent light guide is fixed, static, and immobile relative to the light source the permanent light guide is covering and further relative to the front side (211) of the housing (210) the permanent light guide is coupled therewith.

### Third Illustrated Embodiment

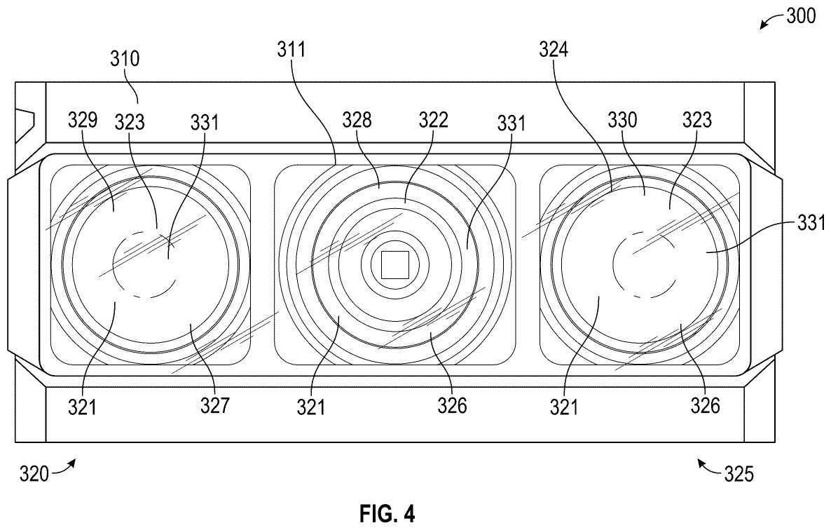

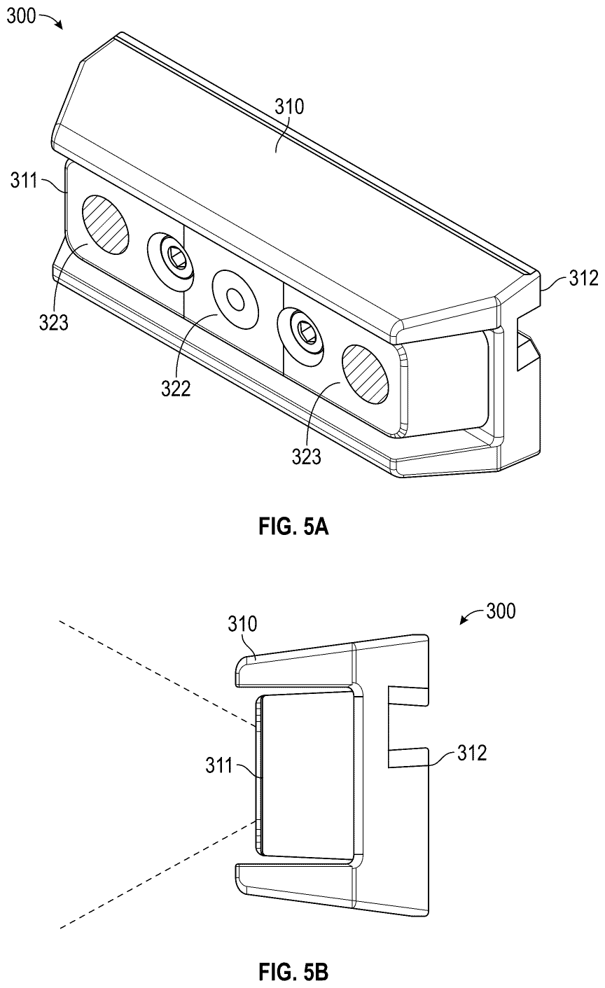

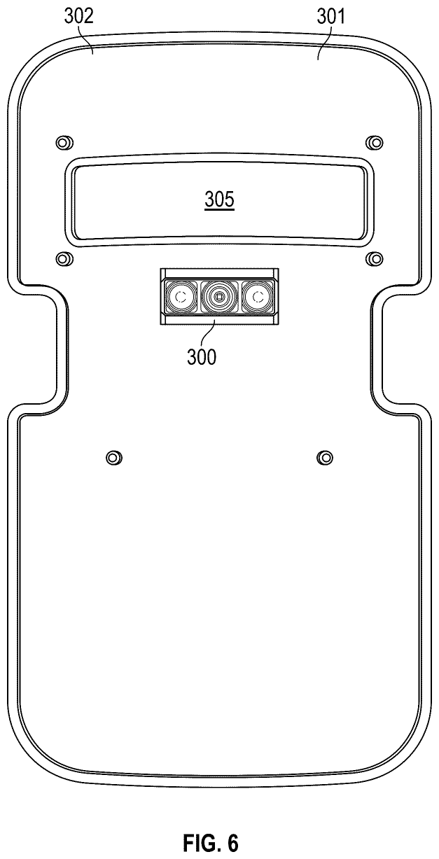

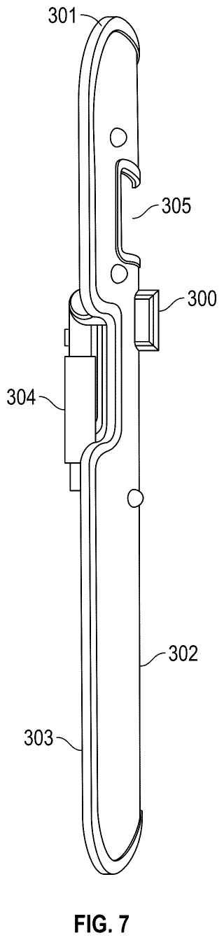

FIG. 4-7 shows a luminary (300) with a plurality of emission angles (325) according to the third illustrated embodiment. The luminary (300) comprises a plurality of light sources (320) arranged collinearly on a housing (310). The plurality of light sources comprises a first light source (328), a second light source (329), and a third light source (330), wherein the first light source is disposed between the second and third light source. Alternative configurations may also be utilized. The plurality of light sources are collectively controlled for synchronous powering on and off. Each light source comprises a light emitting diode (331) disposed on a front side (311) of the housing. The housing further comprises a back side (312) opposite the front side. The housing comprises a plurality of permanent light guides (321), namely a first light guide (322), and a second light guide (323) wherein each of the plurality of permanent light guides is configured to cover one of the plurality of light sources. Each permanent light guide is fixed and immobile to the front side of the housing

The first light guide (322) is disposed over the first light source (328) and is configured to transmit a first emission angle (326). The second light source (329) and the third light source (330) each comprise the second light guide (323), wherein the second light guide is configured to transmit a second emission angle (327). The first emission angle is less than the second emission angle in order for the first light guide to emit a more focused and narrower light emission compared to the second light guide such that the first light source is configured to transmit distance lighting and the second and third light sources are configured to transmit area lighting. Each of the light sources is configured to transmit concurrently with each other, and each light guide associated with one of the plurality of light sources is permanent and configured to continuously transmit an associated emission angle without intervention by a user. As shown, the luminary (300) comprises a number of the first light guides and a number of the second light guides such that the number of the second light guides is greater than the number of the first light guides.

Each permanent light guide (321) comprises a light guide periphery (324) that is separate and distinct from each other light guide periphery. In alternative embodiments, the luminary comprises one or more light guide substrates each comprising a plurality of regions, each of the plurality of regions comprising a light guide configured to transmit light wherein the light guide substrate comprises a plurality of light guides configured to transmit a plurality of emission angles.

The luminary is configured to couple to a ballistic shield (301). The ballistic shield comprises a front surface (302) and a back surface (303) opposite the front surface. A viewing port (305) is disposed on an upper half of the ballistic shield and extends through both the front and back surfaces. A grab handle (304) is coupled to the back surface. The luminary is disposed on the front surface below the viewing port. In other embodiments, the luminary (300) may be coupled to other tactical shields, such as riot shields. In embodiments with riot shields, due to their transparency, the luminary may be disposed on the back surface instead of the front surface in order to mitigate damage by rioters.

Area lighting can be somewhat panoramic to allow for tracking of movements of possible suspects. If a suspect were to run away, the area lighting becomes ineffective due to its lack of distance. Conventionally to achieve the distance lighting, the operator would have to electronically or mechanically change the lighting state. Both require the operator to make a conscious effort to make the change, which can cost time or put the operator in danger. By concurrently transmitting distance and area lighting to create a blended light, the operator can simply shift the ballistic shield to track the potential suspect with the portion of emitted light that is configured for distance lighting.

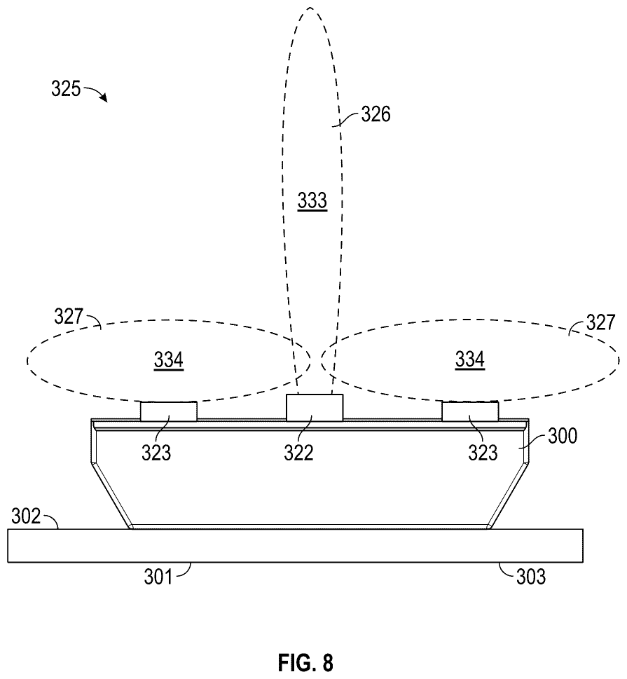

FIG. 8 shows a top view of the luminary (300) with the plurality of emission angles (325) according to the third illustrated embodiment. The luminary is coupled to the front surface (302) of the ballistic shield (301). The luminary comprises a plurality of light sources each having a light guide. A center light source comprises the first light guide (322) configured to produce the first emission angle (326) which is focused for distance lighting (333). Each light source disposed on either side of the center light source comprises the second light guide (323) which is configured to produce the second emission angle (327) wherein the second emission angle is greater than the first emission angle to create a wider and shorter area lighting (334). The result of combining the first emission angle with the second emission angle is a blended light distribution that provides dual advantages of having area and distance lighting concurrently without any alteration by a user. The plurality of light sources is configured to emit a light output in a same direction. In some embodiments, transmission of the plurality of light sources is characterized as being orthogonal to the front side of the housing.

### FEATURE LIST

luminary (100; 200; 300)
plurality of light rows (102)
plurality of light columns (103)
upper half (104)
lower half (105)
first lateral half (106)
second lateral half (107)
housing (110; 210; 310)
front side (111; 211; 311)
plurality of light sources (120; 220; 320)
permanent light guide (121; 221; 321)
first light guide (122; 222; 322)
second light guide (123; 223; 323)
light guide periphery (124; 224; 324)
plurality of emission angles (125; 225; 325)
first emission angle (126; 226; 326)
second emission angle (127; 227; 327)
floodlight (101; 201)
plurality of rotating portions (202)
third light guide (228)
third emission angle (229)
electrified tripod (230)
tripod leg (231)
battery system (232)
charging port (233)
protective light cap (234)
extendable pole (235)
ballistic shield (301)
front surface (302)
back surface (303)
grab handle (304)
viewing port (305)
back side (312)
first light source (328)
second light source (329)
third light source (330)
light emitting diode (331)
distance lighting (333)
area lighting (334)

What is claimed is:

1. A luminary, comprising:
a housing having a front side and a back side opposite the front side;
a plurality of light sources disposed on the front side, wherein each of the plurality of light sources emits a light output in a same direction; and
a plurality of permanent light guides, wherein each of the plurality of permanent light guides is disposed over one of the plurality of light sources, the plurality of permanent light guides comprising a first light guide having a first emission angle and a second light guide having a second emission angle where the first emission angle is less than second emission angle such that the first light guide is configured for distance lighting and the second light guide is configured for area lighting wherein a light output from the area lighting is configured to emit concurrently with a light output from the distance lighting;
wherein at least a portion of the light output from the distance lighting is configured to overlap with at least a portion of the light output of the area lighting

2. The luminary of claim 1, wherein the plurality of light sources is arranged in both a plurality of rows and a plurality of columns.

3. The luminary of claim 1, each of the plurality of light guides further comprising a light guide periphery wherein each light guide periphery is separate and distinct from each of the other light guide peripheries.

4. The luminary of claim 1, the plurality of light guides further comprising a third light guide having a third emission angle wherein the third emission angle is greater than the first emission angle and less than the second emission angle.

5. The luminary of claim 1, wherein the housing is coupled to an extendable pole, the extendable pole being disposed within a tripod having a plurality of legs.

6. The luminary of claim 1, further comprising a plurality of second light guides wherein the first light guide is disposed collinearly with the plurality of second light guides.

7. A luminary, comprising:
a housing having a front side and a back side opposite the front side;
a plurality of light sources disposed on the front side; and
a plurality of light guides, wherein each of the plurality of light guides is disposed over one of the plurality of light sources, the plurality of light guides comprising a first light guide having a first emission angle and a second light guide having a second emission angle, the first emission angle being less than second emission angle, wherein the first light guide is configured for distance lighting and the second light guide is configured for area lighting.

8. The luminary of claim 1, wherein the plurality of light sources is arranged in both a plurality of rows and a plurality of columns.

9. The luminary of claim 1, wherein at least one of the plurality of light guides comprises a permanent light guide.

10. The luminary of claim 1, wherein each of the plurality of light guides comprises a permanent light guide.

11. The luminary of claim 1, each of the plurality of light guides further comprising a light guide periphery wherein each light guide periphery is separate and distinct from each of the other light guide peripheries.

12. The luminary of claim 1, the plurality of light guides further comprising a third light guide having a third emission angle wherein the third emission angle is greater than the first emission angle and less than the second emission angle.

13. The luminary of claim 1, wherein the housing is coupled to an extendable pole, the extendable pole being disposed within a tripod having a plurality of legs.

14. The luminary of claim 1, wherein a light output from the area lighting is configured to emit concurrently with a light output from the distance lighting.

15. The luminary of claim 1, wherein the front side of the housing comprises a plurality of rotating portions such that the first light guide is rotatable relative to the second light guide.

16. The luminary of claim 1, further comprising a plurality of second light guides wherein the first light guide is disposed collinearly with the plurality of second light guides.

17. The luminary of claim 1, wherein each of the plurality of light sources emits a light output in a same direction.

18. The luminary of claim 1, wherein at least a portion of a light output from the distance lighting is configured to overlap with at least a portion of a light output from the area lighting.

19. The luminary of claim 1, wherein the luminary is coupled to a tactical shield at a front surface thereof, the tactical shield further comprising a viewing port extending from the front surface to a back surface opposite the front surface, wherein the luminary is disposed below the viewing port.

20. The luminary of claim 1, the luminary further comprising a number of second light guides and a number of first light guides wherein the number of second light guides is greater than the number of the first light guides.
